(19) United States
(12) Patent Application Publication
(10) Pub. No.: US 2022/0339563 A1
(43) Pub. Date: Oct. 27, 2022

(54) SYSTEMS AND METHODS FOR MANAGING DEBRIS IN A WELL

(71) Applicant: Spoked Solutions LLC, Houma, LA (US)

(72) Inventors: Bryce Elliott Randle, Highlands Ranch, CO (US); Heath Triche, Gray, LA (US); Shane Triche, Houma, LA (US)

(21) Appl. No.: 17/699,171

(22) Filed: Mar. 21, 2022

Related U.S. Application Data
(60) Provisional application No. 63/163,514, filed on Mar. 19, 2021.

(51) Int. Cl. B01D 29/66; B01D 35/157; B01D 29/52; B01D 35/147; B01D 29/01

(52) U.S. Cl. CPC B01D 29/66; B01D 35/1573; B01D 29/52; B01D 35/147; B01D 29/014; E21B 43/35

(57) ABSTRACT

Systems and methods for managing debris material in a fluid are described. In examples, the system may include a flow line that directs a fluid into an inlet of a barrel, through the barrel to filter at least some material from the fluid, and out of an outlet of the barrel. The system may also include a backflush line coupled to the flow line between an inlet valve and an inlet of the barrel and between an outlet valve and an outlet of the barrel. In examples, the system includes a pump positioned on the backflush line, where in a backflush mode, the inlet and outlet valves close to isolate the barrel, and the pump circulates the fluid through the backflush line and through the barrel in a reverse direction to move fluid and material from the barrel to a screen overflow assembly.

### CROSS-REFERENCE TO RELATED APPLICATIONS

This application claims priority to U. S. Provisional Application Ser. No. 63/163,514, filed Mar. 19, 2021, and titled “SYSTEMS AND METHODS FOR MANAGING DEBRIS IN A WELL” the disclosure of which is incorporated herein by reference in its entirety.

### FIELD

The present disclosure relates to debris traps used in oil and gas operations.

### BACKGROUND

Debris traps are used in rig and wellbore operations to remove materials, particulates, and other debris from a fluid that can harm or impede various components and functions of the operation. Back-flushing is a technique to reverse the flow of fluid in a debris trap to remove accumulated debris from the debris trap. However, back-flushing necessarily stops the ability of the debris trap to remove particulars or other debris from a fluid, as it would during normal operation.

### SUMMARY

It is an objective of the present disclosure to provide an apparatus, a system, and/or a method that allows the ability to backflush a debris trap or barrel on the fly without halting the debris filtering functionality of other debris traps or barrels. Several other functions and benefits of the present disclosure are described below.

It is an objective of the present disclosure to backflush, in some embodiments, a single barrel at a time, while allowing other barrels to continue to filter debris. It is another objective of the present disclosure to provide a point in the system at which debris and content can be captured and inspected. In addition, it is an objective of the present disclosure to provide a system where re-pressure testing is not required unless overhaul is performed. It is a further objective to provide the ability to hotswap screens and test pressure on the fly.

In some embodiments, the debris traps or barrels can be arranged into multiple, independent zones. For instance, one embodiment of the present disclosure is a two-zone, independent barrel system where each zone has a primary barrel and a backup barrel. In addition, each zone can have a bypass capability.

Other benefits and functions include (i) secondary containment for barrel capacity, (ii) remote pressure digital readout, (iii) 15,000 psi HP rating, (iv) 200 psi LP rating (double valve isolation per Barrel), (v) 5,700 psi Dp across screens, (vi) greater than 18 bpm per barrel, (vii) greater than 20 bpm when zones are combined, and (viii) 3″ bypass line per zone.

It is an objective of the present disclosure to provide a system where each barrel or debris trap can be backflushed on the fly without shutting down the entire system. The system can include an onboard pump system, water supply, and filtration. In contrast, prior art systems may have a screen filtration system that requires a shutdown of the system to disassemble one or more components of the system to service the components.

It is a further objective of the present disclosure to provide a system where two separate zones of the rig operation can be serviced independently and simultaneously. For example, in some embodiments one zone can be used with a boost line and one zone can be used with a standpipe manifold, all within the same system. In various embodiments, each zone has a primary line, backup line, and bypass line where each line can be accessed and serviced with backflushing on the fly and without shutting down operation of the other lines or zones.

It is an objective of the present disclosure to provide a system where the screens do not have to be removed to be serviced, and screens can be removed on the fly, if damaged, using the double barrier valve isolation system. In some embodiments, the two zones can be combined to provide flow rates of more than 20 bpm without altering the system. It will be appreciated that the system may include greater or fewer barrels that those in the embodiments described herein.

These and other advantages will be apparent from the disclosure(s) contained herein. The above-described embodiments, objectives, and configurations are neither complete nor exhaustive. The Summary is neither intended nor should it be construed as being representative of the full extent and scope of the disclosure. Moreover, references made herein to “the disclosure” or aspects thereof should be understood to mean certain embodiments of the disclosure and should not necessarily be construed as limiting all embodiments to a particular description. The disclosure is set forth in various levels of detail in the Summary as well as in the attached drawings and Detailed Description and no limitation as to the scope of the disclosure is intended by either the inclusion or non-inclusion of elements, components, etc. in this Summary. Additional aspects of the disclosure will become more readily apparent from the Detailed Description particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a schematic view of the system according to an embodiment of the present disclosure;

FIG. 2 includes top view of the system according to an embodiment of the present disclosure;

FIG. 3 includes a front view of the system according to an embodiment of the present disclosure;

FIG. 4 includes a left view of the system according to an embodiment of the present disclosure;

FIG. 5 is a side view of the system according to an embodiment of the present disclosure;

FIG. 6 is a front view of the system according to an embodiment of the present disclosure;

FIG. 7 is a top view of the system according to an embodiment of the present disclosure;

FIG. 8 is a perspective view of the system according to an embodiment of the present disclosure;

FIG. 9 is a first method in accordance with an example of the present disclosure; and

FIG. 10 is a second method in accordance with an example of the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

The disclosure has significant benefits across a broad spectrum of endeavors. It is the Applicant's intent that this specification and the claims appended hereto be accorded a breadth in keeping with the scope and spirit of the disclosure being disclosed despite what might appear to be limiting language imposed by the requirements of referring to the specific examples disclosed. To acquaint persons skilled in the pertinent arts most closely related to the disclosure, a preferred embodiment that illustrates the best mode now contemplated for putting the disclosure into practice is described herein by, and with reference to, the annexed drawings that form a part of the specification. The exemplary embodiment is described in detail without attempting to describe all of the various forms and modifications in which the disclosure might be embodied. As such, the embodiments described herein are illustrative, and as will become apparent to those skilled in the arts, and may be modified in numerous ways within the scope and spirit of the disclosure.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

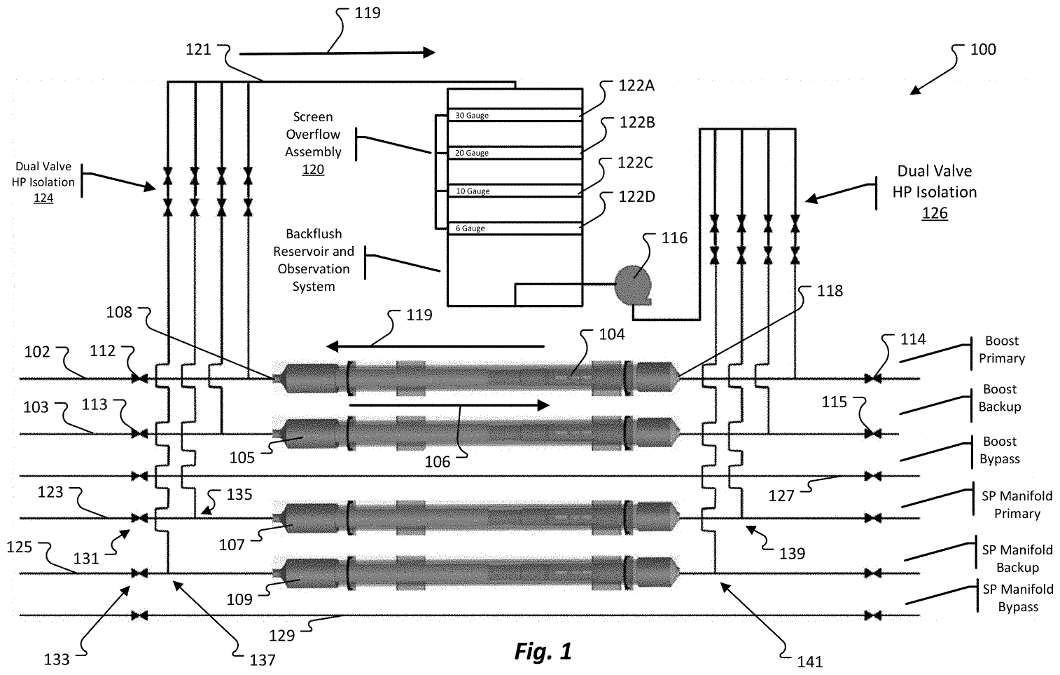

FIG. 1 depicts a schematic view of an embodiment of the system 100. During a filtering operation, a fluid flows through a line 102 and through a barrel, such as barrel 104, in a left-to-right direction 106, as indicated by the arrow and reference character 106. The barrel 104 filters material such as particulate matter from the fluid to reduce the likelihood of the material harming other components of a rig or wellbore operation. For example, and during a filtering operation, a fluid may enter the barrel 104 at the inlet 108, where the barrel 104 subjects the fluid to a filtering process to remove material. In examples, the filtering operation may include passing the fluid through a screen that is of an appropriate size, diameter, tensile, burst, collapse, and/or gauge to be placed within barrel 104. The filtered fluid exits the barrel at the outlet 110. The filtered fluid is then provided to another operation part or zone of the rig operation, such as but not limited to a boost line and/or standpipe manifold.

To clean the material from the barrel 104 in a backflush mode, an inlet valve 112 and an outlet valve 114 may be closed and high-pressure isolation valves 124 and 126 specific to the barrel 104 may be opened such that the pump 116 then circulates fluid in the line 121 in an opposing direction 119 to the left-to-right direction 106. That is, the pump 116 circulates fluid during a backflush mode of operation in the right-to-left direction 119 as indicated by the arrow and reference character 119. Thus, fluid may enter the barrel 104 through the outlet 118 and exit the barrel 104 through the inlet 108. The reverse flow of fluid dislodges and/or cleans the material from the barrel 104 for example and moves the fluid and material through a screen overflow assembly 120 or system where the material is collected using one or more screens 122A-D of appropriate and varying size, diameter, tensile, burst, collapse, and/or gauge. Isolation valves 124 and 126 on either side of the screen overflow assembly 120 can be closed thereby isolating the screen overflow assembly 120 to allow for material collection, inspection, etc. In examples, the fluid flowing through a backflush mode of operation may be a different composition than the fluid flowing in the line 102. In some examples, a fluid reservoir operatively coupled to the line 121, before and/or after the screen overflow assembly 120, may be utilized to provide fluid for the backflush mode of operation.

As further depicted in FIG. 1, the system 100 may be configured to include multiple barrels 104, 105, 107, and/or 109 for example, such that each barrel, or debris trap, can be backflushed on the fly without shutting down the entire system 100. That is, a fluid may flow through a common junction, such as a splitter, “TEE” junction, and/or “Y” junction, and enter the line 102 and 103. During a filtering mode of operation, each of the barrels 104 and 105 may filter fluid originating through the same or common junction. During a backflush mode of operation for a single barrel, a single barrel may be isolated such that another barrel continues to filter fluid. For example, during a backflush mode of operation whereby the barrel 104 is backflushed, an inlet valve 112 may be closed while the inlet valve 113 remains in the open position. Similarly, the outlet valve 114 may be closed while the outlet valve 115 remains in the open position. An isolation valve 124 and isolation valve 126 specific to the barrel 104 may open, thereby allowing fluid to backflush the barrel 104 in a manner previously described. Once the backflush mode of operation specific to the barrel 104 is complete, the isolation valve 124 and isolation valve 126 specific to the barrel 104 may be closed and the inlet valve 112 and outlet valve 114 may be opened, thereby allowing the barrel 104 to filter fluid.

Similarly, during a backflush mode of operation for the barrel 105, an inlet valve 113 may be closed while the inlet valve 112 remains in the open position. The outlet valve 115 may be closed while the outlet valve 114 remains in the open position. An isolation valve 124 and isolation valve 126 specific to the barrel 105 may open, thereby allowing fluid to backflush the barrel 105 in a manner previously described. Once the backflush mode of operation specific to the barrel 105 is complete, the isolation valve 124 and isolation valve 126 specific to the barrel 105 may be closed and the inlet valve 113 and outlet valve 115 may be opened, thereby allowing the barrel 105 to filter fluid. Thus, each of the barrels 104 and 105 can be backflushed at different times thereby allowing the system 100 to remain operational.

In some examples, the system 100 includes two separate zones of the rig operation that can be serviced independently and simultaneously. For example, one zone can be used with a boost line and may include the barrels 104 and 105, and one zone can be used with a standpipe manifold, and may include barrels 107 and 109, where both zones are within the same system 100. Each zone may include multiple lines, such that each line can be accessed and serviced to backflush on the fly without shutting down operation of the other lines or zones. In some examples, each zone may have a primary line (e.g., 102/123), backup line (e.g., 103/125), and bypass line (e.g., 127/129).

In some examples, two zones can be combined to increase filtering and flow rates. For example, two zones can be combined to provide flow rates of more than 20bpm. It will be appreciated that the system may include greater or fewer barrels that those in the examples described herein.

In some examples, the system 100 may provide for the servicing of the screens 122A-122D in a manner such that the screens do not have to be removed; alternatively, or in addition, access is provided to the screens 122A-122D such that one or more of the screens 122A-122D may be removed on the fly if damaged.

FIG. 1 depicts additional barrels (e.g., 105, 107, 109) with spur lines that operably connect the additional barrels to the backflush line. Additional valving allows for a single barrel to operate in a backflush mode without interrupting the normal operation of the other barrels.

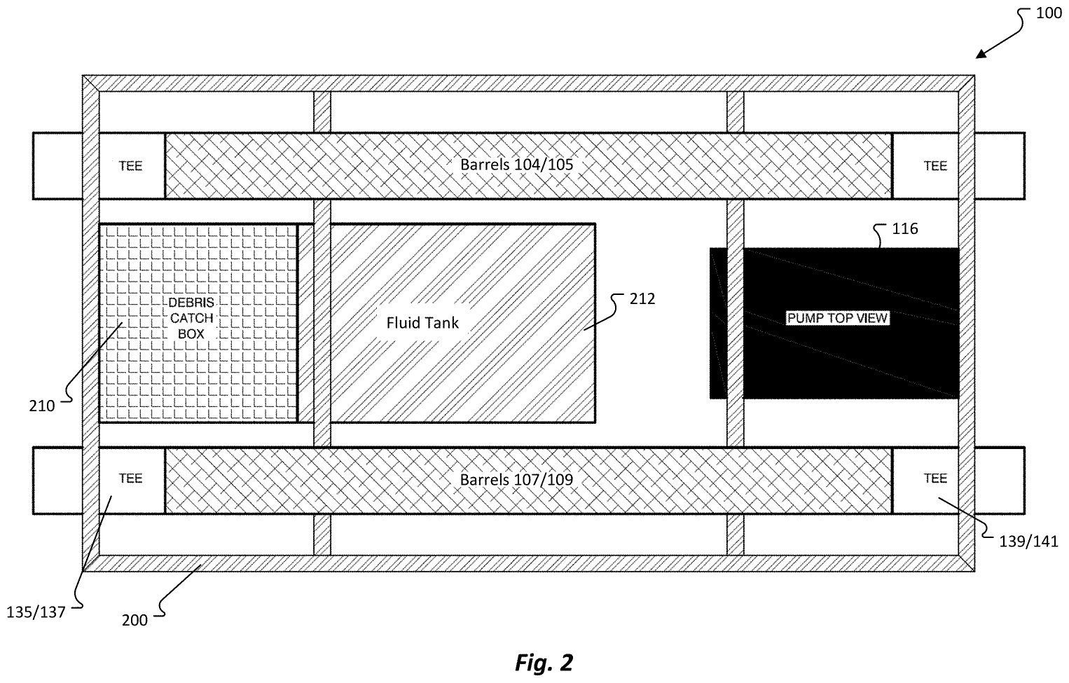

FIG. 2 depicts an additional view (e.g., top view) of the system 100. In examples, the system 100 may be mounted to, contained substantially within, or otherwise connected to a structure or frame assembly 200. While FIG. 2 depicts barrels 104 and 105 in a stacked configuration (e.g., barrel 104 is above barrel 105), such barrels may be included in the system 100 in a different configuration. For example, barrel 104 may be located horizontally next to or beside barrel 105. For each zone, where each zone may include one or more barrels, a junction or splitter may be used to divert or otherwise divide incoming to-be-filtered fluid between barrels included in the zone. For example, a junction or splitter, such as a “TEE” may split and/or divert incoming fluid from a line to one or more of 102/103/127 directed toward barrels 104/105 and/or bypass 127. As another example, a junction or splitter, such as a TEE may split and/or divert incoming fluid from a line to one or more of 123/125/129 directed toward barrels 107/109 and/or bypass 129. Similarly, for each zone, where each zone may include one or more barrels, a junction may be used to combine filtered fluid from barrels into a single line. For example, a junction, such as a TEE may combine filtered fluid from barrels 104 and/or 105 into a single line. As another example, a junction, such as a TEE may combine filtered fluid from barrels 107 and/or 109 into a single line.

For each zone, where each zone may include one or more barrels, a junction or splitter may be used to couple a backflush line 121 to specific barrel in the zone. For example, a junction or splitter, such as a TEE 135 may couple the backflush line 121 via the isolation valves 124 to the barrel 107. Similarly, a junction or splitter, such as a TEE 137 may couple the backflush line 121 via the isolation valves 124 to the barrel 109. Similarly, a junction or splitter, such as a TEE 139 may couple the backflush line 121 via the isolation valves 126 to the barrel 107. Similarly, a junction or splitter, such as a TEE 141 may couple the backflush line 121 via the isolation valves 126 to the barrel 109.

In some examples, the TEEs depicted in FIG. 2 are 3-inch TEEs, though other sizes (e.g., larger and/or smaller) are contemplated. The screen overflow assembly 120 and/or backflush reservoir and observation system may include a fluid tank 212 and/or a debris catch box 210. In examples, the fluid tank 212 may include water. In some examples, the fluid tank may include a different fluid. In some examples, the fluid tank 212 may include fluid for backflushing the barrels (e.g., barrels 104, 105, 107, and/or 109). The debris catch box 210 may include one or more screens to filter or otherwise catch debris and/or material obtained from the backflush mode of operation.

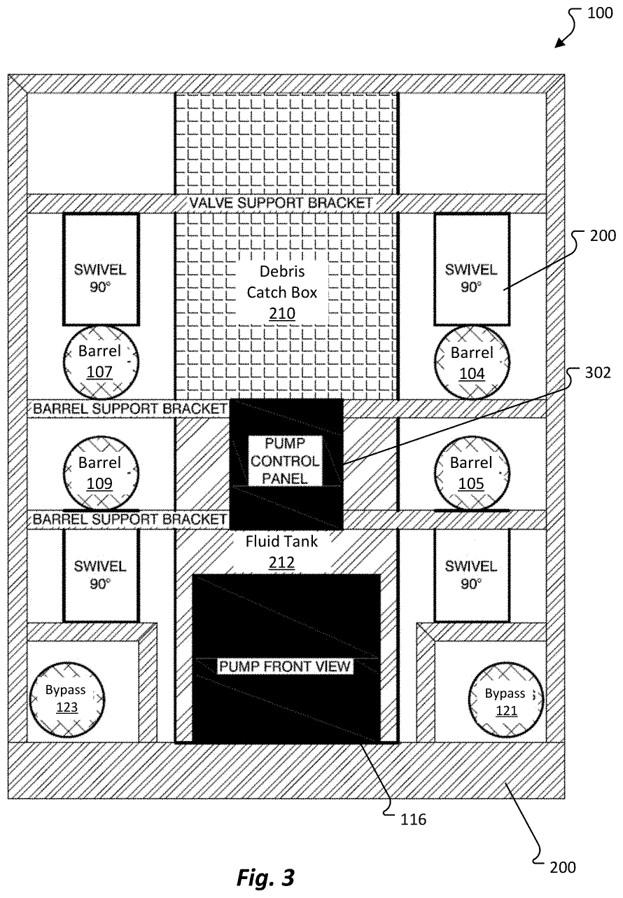

FIG. 3 depicts an additional view (e.g., front view) of the system 100. In examples, the system 100 may be mounted to, contained substantially within, or otherwise connected to a structure or frame assembly 200. While FIG. 3 depicts barrels 104 and 105 in a stacked configuration (e.g., barrel 104 is above barrel 105), such barrels may be included in the system 100 in a different configuration. For example, barrel 104 may be located horizontally next to or beside barrel 105. FIG. 3 further depicts a pump control panel 302 for controlling one or more functions (e.g., on/off, flow-rate, pressure, etc.) of the pump 216. FIG. 3 further depicts various support brackets (e.g., barrel support brackets, valve support brackets, etc.) of which one or more components of the system 100 may be mounted to, connected to, or otherwise secured to. FIG. 3 further depicts one or more swivel assemblies for coupling a backflush line 121 to an inlet of a barrel via one or more TEEs and one or more isolation valves 124. Similarly, FIG. 3 depicts one or more swivel assemblies for coupling a backflush line 121 to an outlet of a barrel via one or more TEEs and one or more isolation valves 126.

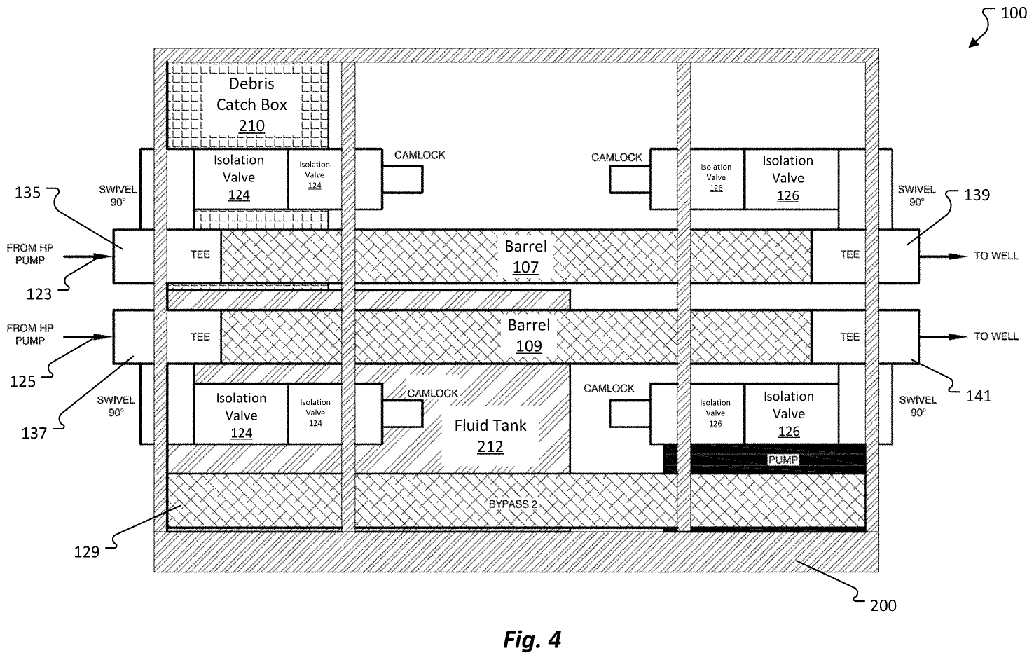

FIG. 4 depicts an additional view (e.g., side view) of the system 100. In examples, the system 100 may be mounted to, contained substantially within, or otherwise connected to a structure or frame assembly 200. As depicted in FIG. 4, one or more swivel assemblies may couple a backflush line 121 to an inlet of a barrel via one or more junctions (e.g., TEEs 135/137) and one or more isolation valves 124. In examples, when in a filtering mode of operation, the fluid provided to the TEE 137 may pass through the valve 133. Similarly, when in a filtering mode of operation, the fluid provided to the TEE 135 may pass through the valve 131. In examples, when in a backflush mode of operation, a backflushing fluid pumped by pump 116, passes through the isolation valves 126, through the TEE 141, through the barrel 109, through the TEE 137 and out to the isolation valves 124. Similarly, when in a backflush mode of operation, a backflushing fluid pumped by pump 116, passes through the isolation valves 126, through the TEE 139, through the barrel 107, through the TEE 135 and out to the isolation valves 124.

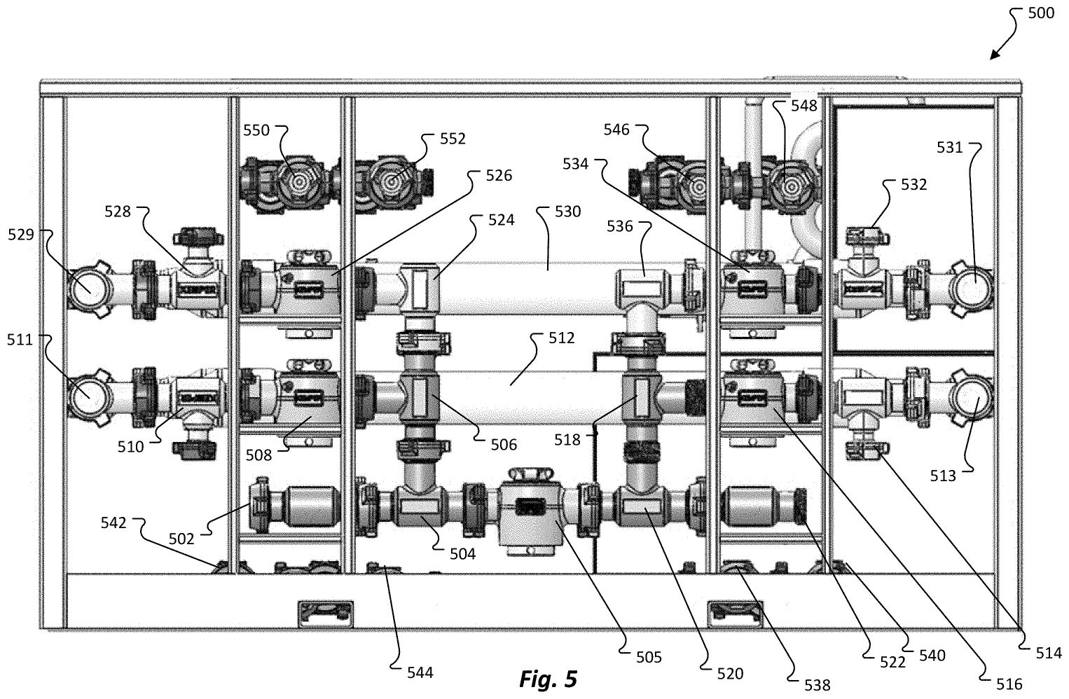

FIG. 5 depicts details of another example system 500 in accordance with examples of the present disclosure. The system 500 may be the same as or similar to the system 100 previously described. In examples, during a filtering operation, a fluid for filtering flows into the system 500 via a coupling or union 502. The fluid may then pass to a junction 504, where the junction 504 may be a TEE type junction. The junction 504 may be coupled to another junction 506, or TEE, that couples two filtering paths also known as two paths of filtration and/or two fluid flow paths. For example, a first filtering path may include a valve 508 and a junction 510 which may be a TEE. For example, the valve 508 may be coupled to the junction 510 and the junction 506. The first filtering path may further include a swivel assembly 511, barrel 512, and swivel assembly 513. The barrel 512 may be the same as or similar to the barrel 104 previously described. The first filtering path may include junction 514 which may be a TEE, valve 516, junction 518 which may be a TEE, junction 520 which may be a TEE, and union or coupling 522. That is, the swivel assembly 511 may be coupled to the barrel 512 and the junction 510. The barrel 512 may be coupled to the swivel assembly 513 which is coupled to the junction 514. The valve 516 may be coupled to the junction 514 and junction 518. The junction 520 may be coupled to the junction 518, the valve 505, and the union or coupling 522. Accordingly, a fluid for filtering may flow into the union or coupling 502, through the junction 504, through the junction 506, through the valve 508, through the junction 510, through the swivel assembly 511, and through the barrel 512. The resulting filtered fluid may then flow through the swivel assembly 513, through the junction 514, through the valve 516, through the junction 518, through the junction 520, and out the union or coupling 522.

A second filtering path may include a valve 526, an elbow 524, and a junction 528 which may be a TEE. For example, the valve 526 may be coupled to the elbow 524, which is coupled to the junction 506, where the valve 526 is coupled to the junction 528. The second filtering path may further include a swivel assembly 529, barrel 530, and swivel assembly 531. The barrel 530 may be the same as or similar to the barrel 104 previously described. The second filtering path may include junction 532 which may be a TEE, valve 534, elbow 536, junction 518 which may be a TEE, junction 520 which may be a TEE, and union or coupling 522. That is, the swivel assembly 529 may be coupled to the barrel 530 and the junction 528. The barrel 530 may be coupled to the swivel assembly 531 which is coupled to the junction 532. The valve 534 may be coupled to the elbow 536. The elbow 536 may be coupled to the junction 518. The junction 520 may be coupled to the junction 518, the valve 505, and the union or coupling 522. Accordingly, a fluid for filtering may flow into the union or coupling 502, through the junction 504, through the junction 506, through the elbow 524, through the valve 526, through the junction 528, through the swivel assembly 529, and through the barrel 530. The resulting filtered fluid may then flow through the swivel assembly 531, through the junction 532, through the valve 534, through the elbow 536, through the junction 518, through the junction 520, and out the union or coupling 522.

In some examples, a bypass fluid flow path may be created and utilized. In such examples, a fluid may flow into the union or coupling 502, into the junction 504, through the valve 505, through the junction 520, and out the union or coupling 522.

During a backflush mode of operation for the barrel 512, backflushing fluid may enter the junction 514 through isolation valves 538 and/or 540. For example, the isolation valve 540 may be coupled to the junction 514. A backflushing mode of operation may cause the backflushing fluid to flow from the swivel assembly 513 through the barrel 512, through the swivel assembly 511, and out the junction 510. The junction 510 may be coupled to the isolation valves 542 and 544, where the isolation valve 544 may be coupled to a screen overflow assembly, such as the screen overflow assembly 120. Similarly, during a backflush mode of operation for the barrel 530, backflushing fluid may enter the junction 532 through isolation valves 546 and/or 548. For example, the isolation valve 548 may be coupled to the junction 532. A backflushing mode of operation may cause the backflushing fluid to flow from the swivel assembly 531 through the barrel 530, through the swivel assembly 529, and out the junction 528. The junction 528 may be coupled to the isolation valves 550 and 552, where the isolation valve 552 may be coupled to a screen overflow assembly, such as the screen overflow assembly 120.

Alternatively, when barrels 512 and 530 are oriented in an opposite direction to that which is described with respect to the first and second filtering paths, described above, a fluid for filtering flows into the system 500 via a coupling or union 522. The fluid may then pass to a junction 520, where the junction 520 may be a TEE type junction. The junction 520 may be coupled to another junction 518, or TEE, that couples two filtering paths also known as two paths of filtration and/or two fluid flow paths. For example, a third filtering path may include a valve 516 and a junction 514 which may be a TEE. The valve 516 may be coupled to the junction 514 and the junction 518. The third filtering path may further include a swivel assembly 513, barrel 512, and swivel assembly 511. The barrel 512 may be the same as or similar to the barrel 104 previously described. The third filtering path may include junction 510 which may be a TEE, valve 508, junction 506 which may be a TEE, junction 504 which may be a TEE, and union or coupling 502. That is, the swivel assembly 513 may be coupled to the barrel 512 and the junction 514. The barrel 512 may be coupled to the swivel assembly 511 which is coupled to the junction 510. The valve 508 may be coupled to the junction 510 and junction 506. The junction 506 may be coupled to the junction 504, the valve 505, and the union or coupling 502. Accordingly, a fluid for filtering may flow into the union or coupling 522, through the junction 520, through the junction 518, through the valve 516, through the junction 514, through the swivel assembly 513, and through the barrel 512. The resulting filtered fluid may then flow through the swivel assembly 511, through the junction 510, through the valve 508, through the junction 506, through the junction 504, and out the union or coupling 502.

A fourth filtering path may include a valve 534, an elbow 536, and a junction 532 which may be a TEE. For example, the valve 534 may be coupled to the elbow 536, which is coupled to the junction 518, where the valve 534 is coupled to the junction 532. The fourth filtering path may further include a swivel assembly 531, barrel 530, and swivel assembly 529. The barrel 530 may be the same as or similar to the barrel 104 previously described. The fourth filtering path may include junction 528 which may be a TEE, valve 526, elbow 524, junction 506 which may be a TEE, junction 504 which may be a TEE, and union or coupling 502. That is, the swivel assembly 531 may be coupled to the barrel 530 and the junction 532. The barrel 530 may be coupled to the swivel assembly 531 which is coupled to the junction 528. The valve 526 may be coupled to the elbow 524. The elbow 524 may be coupled to the junction 506. The junction 506 may be coupled to the junction 504, the valve 505, and the union or coupling 502. Accordingly, a fluid for filtering may flow into the union or coupling 522, through the junction 520, through the junction 518, through the elbow 536, through the valve 534, through the junction 532, through the swivel assembly 531, and through the barrel 530. The resulting filtered fluid may then flow through the swivel assembly 529, through the junction 528, through the valve 526, through the elbow 524, through the junction 506, through the junction 504, and out the union or coupling 502.

In some examples, a bypass fluid flow path may be created and utilized. In such examples, a fluid may flow into the union or coupling 522, into the junction 520, through the valve 505, through the junction 504, and out the union or coupling 502.

Alternatively, when barrels 512 and 530 are oriented in an opposite direction to that which is described with respect to the first and second filtering paths as described above, during a backflush mode of operation for the barrel 512, the backflushing fluid may enter the junction 510 through isolation valves 544 and/or 542. For example, the isolation valve 542 may be coupled to the junction 510. A backflushing mode of operation may cause the backflushing fluid to flow from the swivel assembly 511 through the barrel 512, through the swivel assembly 513, and out the junction 514. The junction 514 may be coupled to the isolation valves 540 and 538, where the isolation valve 538 may be coupled to a screen overflow assembly, such as the screen overflow assembly 120. Similarly, during a backflush mode of operation for the barrel 530, backflushing fluid may enter the junction 528 through isolation valves 552 and/or 550. For example, the isolation valve 550 may be coupled to the junction 528. A backflushing mode of operation may cause the backflushing fluid to flow from the swivel assembly 529 through the barrel 530, through the swivel assembly 531, and out the junction 532. The junction 532 may be coupled to the isolation valves 548 and 546, where the isolation valve 546 may be coupled to a screen overflow assembly, such as the screen overflow assembly 120.

The reverse flow of fluid dislodges and/or cleans the material from the barrels and moves the fluid and material through a screen overflow assembly where the material is collected using one or more screens of appropriate and varying size, diameter, tensile, burst, collapse, and/or gauge. For example, a first screen may be thirty gauge, a second screen maybe twenty gauge, a third screen may be ten gauge, and a fourth screen may be six gauge. Of course, the screen overflow assembly may include more or fewer screens than that which is described. Isolation valves on either side of the screen overflow assembly can be closed thereby isolating the screen overflow assembly to allow for material collection, inspection, etc.

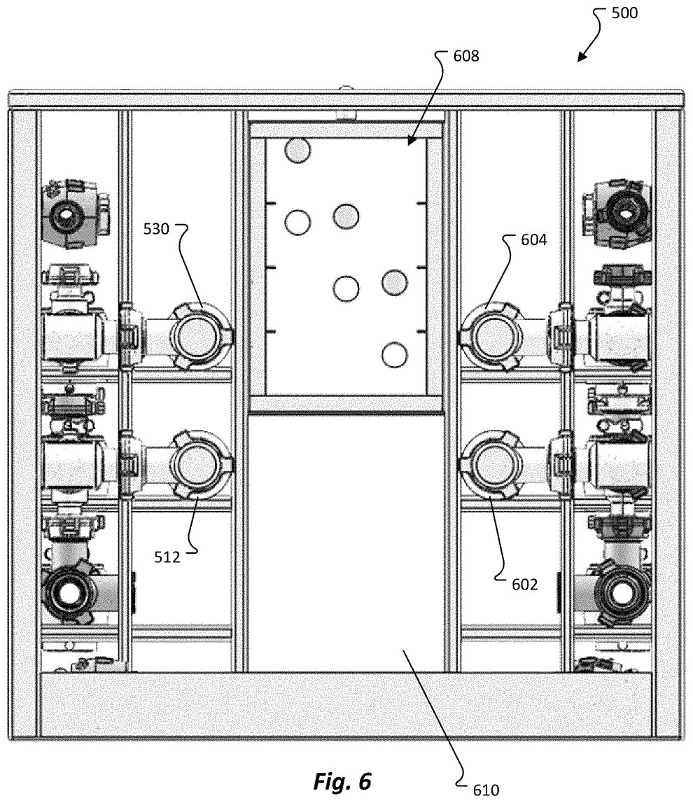

FIG. 6 depicts additional details of the system 500 in accordance with examples of the present disclosure. In examples, FIG. 6 may depict a front view of the system 500. As depicted in FIG. 6, the system 500 may include one or more zones for filtering. As described with respect to FIG. 5, a first zone may include the barrels 512 and 530. The second zone may include barrels 602 and 604 in a same or similar configuration as described with respect to barrels 512 and 530 of FIG. 5. A debris catch box 608 is also depicted which may be the same as or similar to the debris catch box 210. A fluid tank 610 may be the same as or similar to the fluid tank 212. In examples, the system 500 includes a pump, though not depicted in FIG. 6.

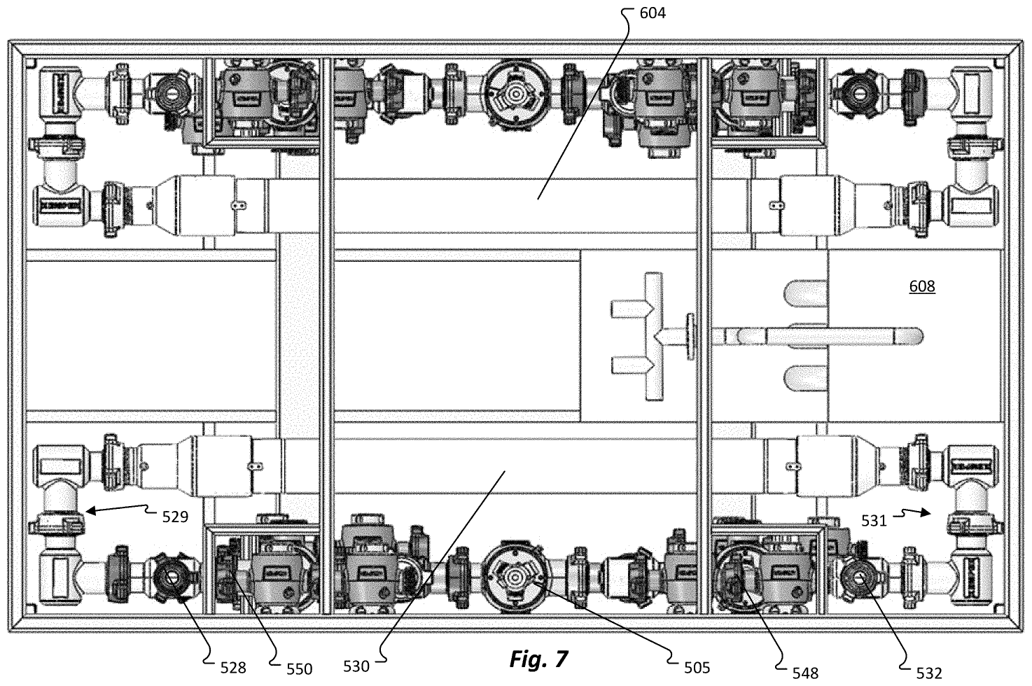

FIG. 7 depicts additional details of the system 500 in accordance with examples of the present disclosure. In examples, FIG. 7 may depict a top view of the system 500. As depicted in FIG. 7, the system 500 may include one or more zones for filtering. As described with respect to FIG. 5, a first zone may include the barrel 530. The second zone may include barrel 604 in a same or similar configuration as described with respect to barrel 530 of FIG. 5. A debris catch box 608 is also depicted which may be the same as or similar to the debris catch box 210.

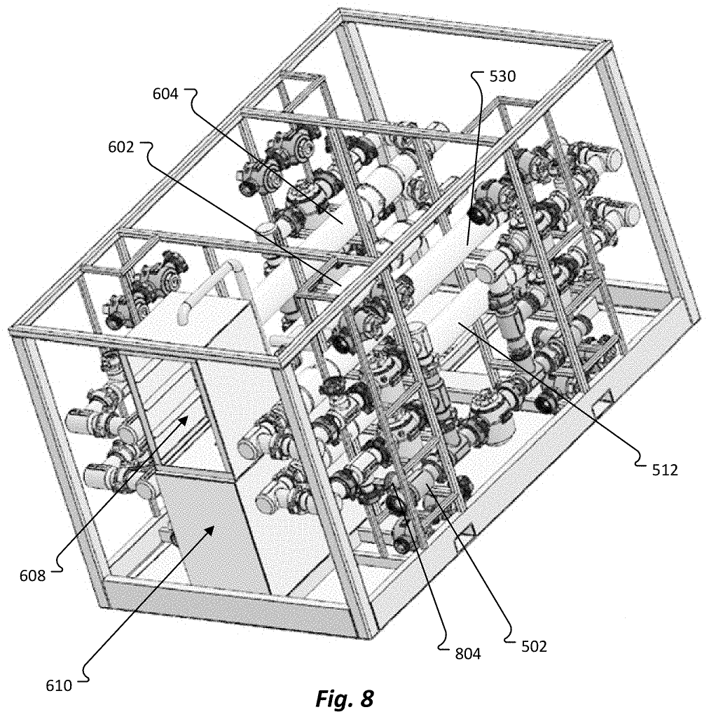

FIG. 8 depicts additional details of the system 500 in accordance with examples of the present disclosure. In examples, FIG. 8 may depict a perspective view of the system 500. As depicted in FIG. 8, the system 500 may include one or more zones for filtering. As described with respect to FIG. 5, a first zone may include the barrels 512 and 530. The second zone may include barrels 602 and 604 in a same or similar configuration as described with respect to barrels 512 and 530 of FIG. 5. A debris catch box 608 is also depicted which may be the same as or similar to the debris catch box 210. A fluid tank 610 may be the same as or similar to the fluid tank 212. In examples, each of the couplings or unions in the system 500 (e.g., 502) may further be configured to be coupled with another zone. That is, in some examples, the coupling or union 502 may be coupled with another coupling or union of another zone to increase the throughput or filter rate of the system 500.

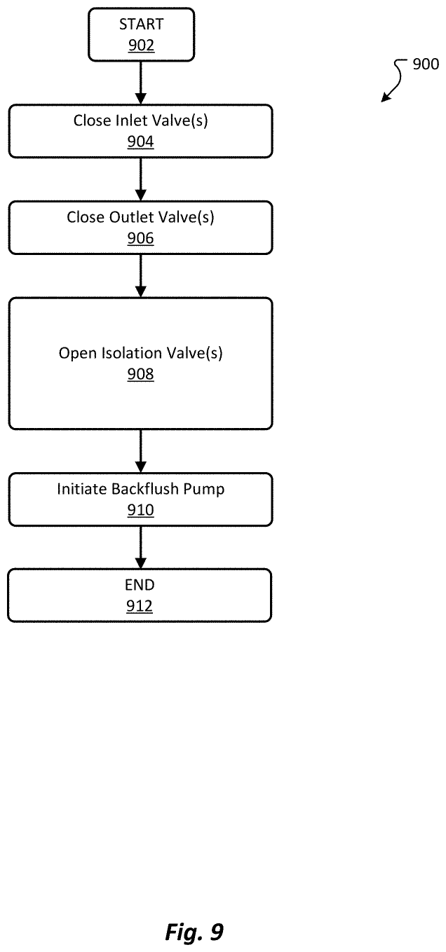

FIG. 9 depicts details of a method 900 for initiating, or otherwise transition to, a backflush operating mode in accordance with examples of the present disclosure. A general order for the steps of the method 900 is shown in FIG. 9. Generally, the method 900 starts at 902 and ends at 912. The method 900 may include more or fewer steps or may arrange the order of the steps differently than those shown in FIG. 9. Hereinafter, the method 900 shall be explained with reference to the systems and components described in conjunction with FIGS. 1-8.

The method 900 starts at 902, where a backflush operating mode may be initiated. The method may then proceed to 904, where one or more inlet valves specific to a barrel are closed. For example, an inlet valve 112 and/or valve 508 may be closed. The method 500 may proceed to 906, where one or more outlet valves specific to a barrel are closed. For example, an outlet valve 114 and/or valve 516 may be closed. The method 900 may proceed to 908, where isolation valves specific to a barrel are opened. In examples, isolation valves 124 and 126 specific to a barrel, such as barrel 104, are opened. Similarly, isolation valves 538, 540, 542, and 544 are opened. The method may proceed to 910, where a pump may begin pumping or otherwise supplying backflushing fluid to one or more isolation valves causing the backflushing fluid to flow in a direction that is opposite to a filtering flow operation. The method 900 may end at 912.

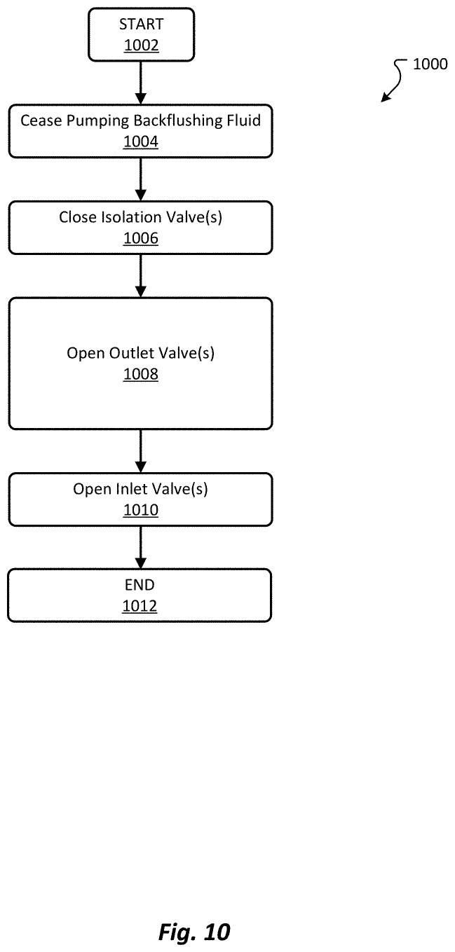

FIG. 10 depicts details of a method 1000 for initiating, or otherwise transition from a backflush filtering mode to a fluid filtering mode in accordance with examples of the present disclosure. A general order for the steps of the method 1000 is shown in FIG. 10. Generally, the method 1000 starts at 1002 and ends at 1012. The method 1000 may include more or fewer steps or may arrange the order of the steps differently than those shown in FIG. 10. Hereinafter, the method 1000 shall be explained with reference to the systems and components described in conjunction with FIGS. 1-9.

The method 1000 starts at 1002, where a transition from a backflush operating mode to a fluid filtering mode may be initiated. The method may then proceed to 1004, where a pump pumping or otherwise supplying backflushing fluid to one or more isolation valves may stop pumping backflushing fluid in a direction that is opposite to a filtering flow operation. The method may proceed to 1006, where isolation valves specific to a barrel are closed. In examples, isolation valves 124 and 126 specific to a barrel, such as barrel 104, are closed. Similarly, isolation valves 538, 540, 542, and 544 are closed. The method may then proceed to 1008, where one or more outlet valves specific to a barrel are opened. For example, an outlet valve 114 and/or valve 516 may be opened. The method 1000 may proceed to 1010, where one or more inlet valves specific to a barrel are opened. For example, an inlet valve 112 and/or valve 508 may be opened. The method 1000 may end at 1012.

To provide additional background, context, and to further satisfy the written description requirements of 35 U.S.C. § 112, the following references are incorporated by reference herein in their entireties: U.S. Pat. No. 10,100,615, which provides descriptions of debris traps that may be used in combination with the system described herein.

The disclosure has significant benefits across a broad spectrum of endeavors. It is the Applicant's intent that this specification and the claims appended hereto be accorded a breadth in keeping with the scope and spirit of the disclosure being disclosed despite what might appear to be limiting language imposed by the requirements of referring to the specific examples disclosed.

The phrases “at least one”, “one or more”, and “and/or”, as used herein, are open-ended expressions that are both conjunctive and disjunctive in operation. For example, each of the expressions “at least one of A, B, and C”, “at least one of A, B, or C”, “one or more of A, B, and C”, “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts, and the equivalents thereof, shall include all those described in the Summary, Brief Description of the Drawings, Detailed Description, Abstract, and claims themselves.

In accordance with examples of the present disclosure, a system for managing debris material is described. The system may include a flow line that directs a fluid into an inlet of a barrel, through the barrel to filter at least some material from the fluid, and out of an outlet of the barrel, wherein an inlet valve is positioned on the flow line proximate to the inlet and an outlet valve is positioned on the flow line proximate to the outlet. The system may include a backflush line coupled to the flow line between the inlet valve and the inlet of the barrel and between the outlet valve and the outlet of the barrel. The system may include a screen overflow assembly positioned on the backflush line, wherein the screen overflow assembly has one screen positioned below another screen to collect material from the fluid. The system may include a pump positioned on the backflush line, wherein in a backflush mode, the inlet and outlet valves close to isolate the barrel, and the pump circulates the fluid through the backflush line and through the barrel in a reverse direction to move fluid and material from the barrel to the screen overflow assembly.

At least one aspect of the above system includes at least one isolation valve on the backflush line on one side of the screen overflow assembly and at least one isolation valve on the backflush line on an opposing side of the screen overflow assembly, wherein the isolation valves close to isolate the screen overflow assembly for maintenance and inspection.

At least one aspect of the above system includes a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel; a first spur line extending from the second flow line between the second inlet valve and the inlet of the second barrel to the backflush line; and a second spur line extending from the second flow line between the second outlet valve and the outlet of the second barrel to the backflush line, wherein in second backflush mode, the first inlet valve is open, the second inlet valve is closed, the first outlet valve is open and the second outlet valve is closed, the pump circulates the fluid through the backflush line and through the second barrel in a reverse direction to move fluid and material from the second barrel to the screen overflow assembly, and the fluid is directed into the inlet of the barrel, through the barrel to filter at least some material from the fluid, and out of the outlet of the barrel.

At least one aspect of the above system includes a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel; a first spur line extending from the second flow line between the second inlet valve and the inlet of the second barrel to the backflush line; and a second spur line extending from the second flow line between the second outlet valve and the outlet of the second barrel to the backflush line, wherein in a second backflush mode, the second inlet valve and the second outlet valve close to isolate the second barrel, and the pump circulates the fluid through the backflush line and through the second barrel in a reverse direction to move fluid and material from the second barrel to the screen overflow assembly.

At least one aspect of the above system includes a third flow line that directs a fluid into an inlet of a bypass valve.

At least one aspect of the above system includes when in a bypass operation, the first and second inlet valves are closed, the first and second outlet valves are closed, and the fluid bypasses the first and second barrels by passing through the bypass valve.

At least one aspect of the above system includes a second flow line that directs the fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel, wherein the backflush line extends from the flow line between the second inlet valve and the second inlet to the flow line between the second outlet valve and the second outlet, and wherein the outlet valve is coupled to a component different from the second outlet valve.

At least one aspect of the above system includes where the outlet valve is coupled to a boost line and the second outlet valve is coupled to a standpipe manifold.

At least one aspect of the above system includes a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel; a first spur line extending from the second flow line between the second inlet valve and the inlet of the second barrel to the backflush line; and a second spur line extending from the second flow line between the second outlet valve and the outlet of the second barrel to the backflush line, wherein in a filtering mode, the inlet valve, the outlet valve, the second inlet valve, and the second outlet valve are open such that the fluid is directed into the inlet of a barrel, through the barrel to filter at least some material from the fluid, and into the inlet of the second barrel, through the second barrel to filter at least some material from the fluid.

At least one aspect of the above system includes at least two isolation valves on the backflush line on one side of the screen overflow assembly and at least two isolation valves on the backflush line on an opposing side of the screen overflow assembly, wherein the isolation valves close to isolate the screen overflow assembly for maintenance and inspection.

In accordance with at least one aspect of the present disclosure, a system for managing debris material is described. The system may include a zone including a first barrel and a second barrel configured to filter at least some material from a fluid. The system may include a first inlet valve positioned proximate to an inlet of the first barrel; a first outlet valve positioned proximate to an outlet of the first barrel; a second inlet valve positioned proximate to an inlet of the second barrel; and a first outlet valve positioned proximate to an outlet of the second barrel, wherein in a backflush mode, the first inlet valve and the first outlet valve close such that a backflush fluid flows through the first barrel in a reverse direction to move the backflush fluid and material from the first barrel to a screen overflow assembly.

At least one aspect of the above system includes a pump positioned on a backflush line coupled to the inlet of the first barrel, the outlet of the first barrel, the inlet of the second barrel, and the outlet of the second barrel, wherein in the backflush mode, the pump circulates the backflush fluid through the backflush line and through the first barrel.

At least one aspect of the above system includes at least one isolation valve on the backflush line on one side of the screen overflow assembly and at least one isolation valve on the backflush line on an opposing side of the screen overflow assembly, wherein the isolation valves close to isolate the screen overflow assembly for maintenance and inspection.

At least one aspect of the above system includes when in a filter mode, the first inlet valve, the first outlet valve, the second inlet valve, and the second outlet valve are open to filter at least some material from the fluid.

At least one aspect of the above system includes a second zone including a third barrel and a fourth barrel configured to filter at least some material from the fluid; a third inlet valve positioned proximate to an inlet of the third barrel; a third outlet valve positioned proximate to an outlet of the third barrel; a fourth inlet valve positioned proximate to an inlet of the fourth barrel; and a fourth outlet valve positioned proximate to an outlet of the fourth barrel, wherein in a backflush mode, the first inlet valve and the first outlet valve close such that the backflush fluid flows through the first barrel in the reverse direction to move the backflush fluid and material from the first barrel to the screen overflow assembly, and the third inlet valve and the third outlet valve close such that the backflush fluid flows through the third barrel in the reverse direction to move the backflush fluid and material from the third barrel to the screen overflow assembly.

At least one aspect of the above system includes a first junction configured to combine the filtered fluid from the first zone; and a second junction configured to combine the filtered fluid from the second zone, wherein the first zone is coupled to a component different from the second zone.

At least one aspect of the above system includes where the first zone is coupled to a boost line and the second zone is coupled to a standpipe manifold.

In accordance with examples of the present disclosure, a method for backflushing a first barrel configured to filter at least some material from a fluid is described. The method may include closing a first inlet valve positioned proximate to an inlet of the first barrel; closing a first outlet valve positioned proximate to an outlet of the first barrel; opening at least one isolation valve position between a backflush pump and the outlet of the first barrel; opening at least one isolation valve position between a screen overflow assembly and the inlet of the first barrel; and while a second barrel filters at least some material from a fluid, pumping, using the backflush pump, backflush liquid through the first barrel to move the backflush fluid and material from the first barrel to the screen overflow assembly.

At least one aspect of the above method system includes filtering, by the screen overflow assembly, the material from the backflush fluid.

At least one aspect of the above method includes transitioning the first barrel from a backflush mode to a filter mode such that the first barrel filters at least some material from the fluid by: closing the least one isolation valve positioned between the backflush pump and the outlet of the first barrel; closing the at least one isolation valve positioned between the screen overflow assembly and the inlet of the first barrel; opening the first outlet valve positioned proximate to the outlet of the first barrel; and opening the first inlet valve positioned proximate to the inlet of the first barrel.

The foregoing description of the disclosure has been presented for illustration and description purposes. However, the description is not intended to limit the disclosure to only the forms disclosed herein. In the foregoing Detailed Description for example, various features of the disclosure are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Consequently, variations and modifications commensurate with the above teachings and skill and knowledge of the relevant art are within the scope of the disclosure. The embodiments described herein above are further intended to explain best modes of practicing the disclosure and to enable others skilled in the art to utilize the disclosure in such a manner, or include other embodiments with various modifications as required by the particular application(s) or use(s) of the disclosure. Thus, it is intended that the claims be construed to include alternative embodiments to the extent permitted by the prior art.

What is claimed is:

1. A system for managing debris material, comprising:
a flow line that directs a fluid into an inlet of a barrel, through the barrel to filter at least some material from the fluid, and out of an outlet of the barrel, wherein an inlet valve is positioned on the flow line proximate to the inlet and an outlet valve is positioned on the flow line proximate to the outlet;
a backflush line coupled to the flow line between the inlet valve and the inlet of the barrel and between the outlet valve and the outlet of the barrel;
a screen overflow assembly positioned on the backflush line, wherein the screen overflow assembly has one screen positioned below another screen to collect material from the fluid; and
a pump positioned on the backflush line, wherein in a backflush mode, the inlet and outlet valves close to isolate the barrel, and the pump circulates the fluid through the backflush line and through the barrel in a reverse direction to move fluid and material from the barrel to the screen overflow assembly.

2. The system of claim 1, further comprising at least one isolation valve on the backflush line on one side of the screen overflow assembly and at least one isolation valve on the backflush line on an opposing side of the screen overflow assembly, wherein the isolation valves close to isolate the screen overflow assembly for maintenance and inspection.

3. The system of claim 2, further comprising a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel;
a first spur line extending from the second flow line between the second inlet valve and the inlet of the second barrel to the backflush line; and
a second spur line extending from the second flow line between the second outlet valve and the outlet of the second barrel to the backflush line,
wherein in second backflush mode, the first inlet valve is open, the second inlet valve is closed, the first outlet valve is open and the second outlet valve is closed, the pump circulates the fluid through the backflush line and through the second barrel in a reverse direction to move fluid and material from the second barrel to the screen overflow assembly, and the fluid is directed into the inlet of the barrel, through the barrel to filter at least some material from the fluid, and out of the outlet of the barrel.

4. The system of claim 1, further comprising a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel;
a first spur line extending from the second flow line between the second inlet valve and the inlet of the second barrel to the backflush line; and
a second spur line extending from the second flow line between the second outlet valve and the outlet of the second barrel to the backflush line,
wherein in a second backflush mode, the second inlet valve and the second outlet valve close to isolate the second barrel, and the pump circulates the fluid through the backflush line and through the second barrel in a reverse direction to move fluid and material from the second barrel to the screen overflow assembly.

5. The system of claim 4, further comprising a third flow line that directs a fluid into an inlet of a bypass valve.

6. The system of claim 5, wherein in a bypass operation, the first and second inlet valves are closed, the first and second outlet valves are closed, and the fluid bypasses the first and second barrels by passing through the bypass valve.

7. The system of claim 1, further comprising further comprising:
a second flow line that directs the fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel, wherein the backflush line extends from the flow line between the second inlet valve and the second inlet to the flow line between the second outlet valve and the second outlet, and wherein the outlet valve is coupled to a component different from the second outlet valve.

8. The system of claim 7, wherein the outlet valve is coupled to a boost line and the second outlet valve is coupled to a standpipe manifold.

9. The system of claim 1, further comprising a second flow line that directs a fluid into an inlet of a second barrel, through the second barrel to filter at least some material from the fluid, and out of an outlet of the second barrel, wherein a second inlet valve is positioned on the second flow line proximate to the inlet of the second barrel and a second outlet valve is positioned on the second flow line proximate to the outlet of the second barrel;
a first spur line extending from the second flow line between the second inlet valve and the inlet of the second barrel to the backflush line; and
a second spur line extending from the second flow line between the second outlet valve and the outlet of the second barrel to the backflush line,
wherein in a filtering mode, the inlet valve, the outlet valve, the second inlet valve, and the second outlet valve are open such that the fluid is directed into the inlet of a barrel, through the barrel to filter at least some material from the fluid, and into the inlet of the second barrel, through the second barrel to filter at least some material from the fluid.

10. The system of claim 1, further comprising at least two isolation valves on the backflush line on one side of the screen overflow assembly and at least two isolation valves on the backflush line on an opposing side of the screen overflow assembly, wherein the isolation valves close to isolate the screen overflow assembly for maintenance and inspection.

11. A system for managing debris material, comprising:
a zone including a first barrel and a second barrel configured to filter at least some material from a fluid;
a first inlet valve positioned proximate to an inlet of the first barrel;
a first outlet valve positioned proximate to an outlet of the first barrel;
a second inlet valve positioned proximate to an inlet of the second barrel; and
a first outlet valve positioned proximate to an outlet of the second barrel,
wherein in a backflush mode, the first inlet valve and the first outlet valve close such that a backflush fluid flows through the first barrel in a reverse direction to move the backflush fluid and material from the first barrel to a screen overflow assembly.

12. The system of claim 11, further comprising:
a pump positioned on a backflush line coupled to the inlet of the first barrel, the outlet of the first barrel, the inlet of the second barrel, and the outlet of the second barrel, wherein in the backflush mode, the pump circulates the backflush fluid through the backflush line and through the first barrel.

13. The system of claim 12, further comprising at least one isolation valve on the backflush line on one side of the screen overflow assembly and at least one isolation valve on the backflush line on an opposing side of the screen overflow assembly, wherein the isolation valves close to isolate the screen overflow assembly for maintenance and inspection.

14. The system of claim 11, wherein in a filter mode, the first inlet valve, the first outlet valve, the second inlet valve, and the second outlet valve are open to filter at least some material from the fluid.

15. The system of claim 11, further comprising:
a second zone including a third barrel and a fourth barrel configured to filter at least some material from the fluid;
a third inlet valve positioned proximate to an inlet of the third barrel;
a third outlet valve positioned proximate to an outlet of the third barrel;
a fourth inlet valve positioned proximate to an inlet of the fourth barrel; and
a fourth outlet valve positioned proximate to an outlet of the fourth barrel,
wherein in a backflush mode, the first inlet valve and the first outlet valve close such that the backflush fluid flows through the first barrel in the reverse direction to move the backflush fluid and material from the first barrel to the screen overflow assembly, and the third inlet valve and the third outlet valve close such that the backflush fluid flows through the third barrel in the reverse direction to move the backflush fluid and material from the third barrel to the screen overflow assembly.

16. The system of claim 15, further comprising:
a first junction configured to combine the filtered fluid from the first zone; and
a second junction configured to combine the filtered fluid from the second zone, wherein the first zone is coupled to a component different from the second zone.

17. The system of claim 16, wherein the first zone is coupled to a boost line and the second zone is coupled to a standpipe manifold.

18. A method for backflushing a first barrel configured to filter at least some material from a fluid, the method comprising:
closing a first inlet valve positioned proximate to an inlet of the first barrel;
closing a first outlet valve positioned proximate to an outlet of the first barrel;
opening at least one isolation valve position between a backflush pump and the outlet of the first barrel;
opening at least one isolation valve position between a screen overflow assembly and the inlet of the first barrel; and
while a second barrel filters at least some material from a fluid, pumping, using the backflush pump, backflush liquid through the first barrel to move the backflush fluid and material from the first barrel to the screen overflow assembly.

19. The method of claim 18, further comprising:
filtering, by the screen overflow assembly, the material from the backflush fluid.

20. The method of claim 18, further comprising transitioning the first barrel from a backflush mode to a filter mode such that the first barrel filters at least some material from the fluid by:
closing the least one isolation valve positioned between the backflush pump and the outlet of the first barrel;
closing the at least one isolation valve positioned between the screen overflow assembly and the inlet of the first barrel;
opening the first outlet valve positioned proximate to the outlet of the first barrel; and
opening the first inlet valve positioned proximate to the inlet of the first barrel.
